(19) United States
(12) Patent Application Publication
(10) Pub. No.: US 2026/0140303 A1
(43) Pub. Date: May 21, 2026

(54) PHOTONIC CHIPS INCLUDING A PHASE SHIFTER

(71) Applicant: GlobalFoundries U.S. Inc., Malta, NY (US)

(72) Inventors: Oscar Restrepo, Halfmoon, NY (US); Riddhi Nandi, Bangalore (IN); Anupam Dutta, Bangalore (IN); Vibhor Jain, Essex Junction, VT (US); Alexander Derrickson, Saratoga Springs, NY (US); Rui Tze Toh, Singapore (SG); VVSS Satyasuresh Choppalli, Bangalore (IN); Ravi Prakash Srivastava, Clifton Park, NY (US)

(21) Appl. No.: 18/951,893

(22) Filed: Nov. 19, 2024

(51) Int. Cl. G02B 6/12

(52) U.S. Cl. CPC G02B 6/12004; G02B 6/12002; G02B 2006/12061; G02B 2006/12135; G02B 2006/12147

(57) ABSTRACT

Structures including a phase shifter and methods of forming such structures. The structure comprises a dielectric layer, a heater on the dielectric layer, a back-end-of-line stack on the dielectric layer and the heater, a substrate, and a second back-end-of-line stack on the substrate. The second back-end-of-line stack adjoins the first back-end-of-line stack along a bonding interface. The structure further comprises a waveguide core on the dielectric layer. The waveguide core includes a section that overlaps with the heater.

### BACKGROUND

The disclosure relates to photonic chips and, more specifically, to structures including a phase shifter and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

A phase shifter is a photonic component that can be used on a photonic chip to modulate the phase of light propagating in a waveguide core. One type of phase shifter may operate by a thermo-optic mechanism in which heat is generated and transferred to the waveguide core, which is comprised of a material having a refractive index that varies with temperature.

Improved structures including a phase shifter and methods of forming such structures are needed.

### SUMMARY

In an embodiment, a structure comprises a dielectric layer, a heater on the dielectric layer, a back-end-of-line stack on the dielectric layer and the heater, a substrate, and a second back-end-of-line stack on the substrate. The second back-end-of-line stack adjoins the first back-end-of-line stack along a bonding interface. The structure further comprises a waveguide core on the dielectric layer. The waveguide core includes a section that overlaps with the heater.

In an embodiment, a method comprises forming a heater on a dielectric layer, forming a first back-end-of-line stack on the dielectric layer and the heater, and bonding a second back-end-of-line stack to the first back-end-of-line stack along a bonding interface. The second back-end-of-line stack is positioned on a substrate. The method further comprises forming a waveguide core on the dielectric layer. The waveguide core includes a section that overlaps with the heater.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals are used to indicate like features in the various views.

FIG. 1 is a cross-sectional view of a structure in accordance with embodiments of the invention.

FIG. 2 is a cross-sectional view of the structure at a fabrication stage subsequent to FIG. 1.

FIG. 3 is a cross-sectional view of a structure in accordance with alternative embodiments of the invention.

FIG. 4 is a cross-sectional view of a structure in accordance with alternative embodiments of the invention.

FIG. 5 is a cross-sectional view of a structure in accordance with alternative embodiments of the invention.

FIG. 6 is a cross-sectional view of a structure in accordance with alternative embodiments of the invention.

### DETAILED DESCRIPTION

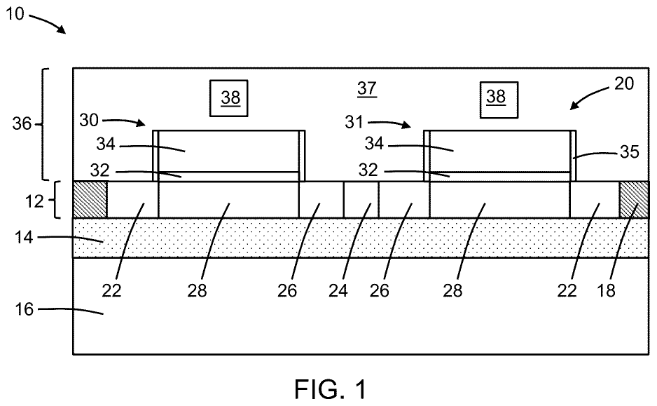

With reference to FIG. 1 and in accordance with embodiments of the invention, a structure 10 for a photonic chip includes a semiconductor layer 12, a dielectric layer 14, and a semiconductor substrate 16. In an embodiment, the dielectric layer 14 may be comprised of a dielectric material, such as an oxide of silicon like silicon dioxide, and the semiconductor substrate 16 may be comprised of a semiconductor material, such as single-crystal silicon. In an embodiment, the dielectric layer 14 may be a buried oxide layer of a silicon-on-insulator substrate, and the dielectric layer 14 may be disposed between the semiconductor layer 12 and the semiconductor substrate 16. In an embodiment, the dielectric layer 14 may have a thickness that ranges from about one (1) micrometer to about two (2) micrometers.

Shallow trench isolation regions 18 may surround a device region of the semiconductor layer 12. The shallow trench isolation regions 18 may be formed by patterning trenches in the semiconductor layer 12 with lithography and etching processes, depositing a dielectric material, such as an oxide of silicon like silicon dioxide, in the trenches, and recessing and/or planarizing the deposited dielectric material.

A device structure 20 may be formed in the device region of the semiconductor layer 12. The device structure 20 may include doped regions 22, a doped region 24, doped regions 26, and doped regions 28 that are formed in respective portions of the semiconductor layer 12. In an embodiment, the doped regions 22 and the doped region 24 may represent source/drain regions of the device structure 20. As used herein, the term “source/drain region” means a region of semiconductor material that can function as either a source or a drain of a field-effect transistor. In an embodiment, the doped regions 22 may represent sources of the device structure 20, the doped region 24 may represent a drain of the device structure 20, the doped regions 26 may represent drift regions or extended drains of the device structure 20, and the doped regions 28 may represent bodies of the device structure 20 that are arranged laterally between the sources and drain.

The device structure 20 may be characterized as a power field-effect transistor. In an embodiment, the device structure 20 may be a laterally-diffused metal-oxide-semiconductor device in which the doped regions 26 represent drift regions. In an embodiment, the device structure 20 may be an extended-drain metal-oxide-semiconductor device in which the doped regions 26 represent extended drains. In an alternative embodiment, the device structure 20 may be a double-diffused metal-oxide-semiconductor structure.

The doped regions 22, the doped region 24, and the doped regions 26 may have a different conductivity type from the doped regions 28. In an embodiment, the doped regions 22, the doped region 24, and the doped regions 26 may be characterized by n-type conductivity and the doped regions 28 may be characterized by p-type conductivity. In an alternative embodiment, the doped regions 22, the doped region 24, and the doped regions 26 may be characterized by p-type conductivity and the doped regions 28 may be characterized by n-type conductivity. A silicide-blocking layer (not shown) may be formed over the doped region 24 and the doped regions 26.

In an embodiment, the doped regions 22 and the doped region 24 may contain a concentration of an n-type dopant, such as phosphorus, to provide n-type conductivity. The doped regions 22 and the doped region 24 may be concurrently formed by selectively implanting ions, such as ions including the n-type dopant, with an implantation mask having openings defining the intended locations for the doped regions 22 and the doped region 24 in the semiconductor layer 12. The implantation conditions, such as ion species, dose, and kinetic energy, may be selected to tune the electrical and physical characteristics of the doped regions 22 and the doped region 26.

The doped regions 26 may be formed by selectively implanting ions, such as ions including the n-type dopant, with an implantation mask having openings defining the intended locations for the doped regions 26 in the semiconductor layer 12. The implantation conditions, such as ion species, dose, and kinetic energy, may be selected to tune the electrical and physical characteristics of the doped regions 26. In an embodiment, the doped regions 22 and the doped region 24 may contain a higher dopant concentration than the doped regions 26.

In an embodiment, the doped regions 28 may contain a concentration of a p-type dopant, such as boron, to provide p-type conductivity. The doped regions 28 may be formed by selectively implanting ions, such as ions including the p-type dopant, with an implantation mask having openings defining the intended locations for the doped regions 28 in the semiconductor layer 12. The implantation conditions, such as ion species, dose, and kinetic energy, may be selected to tune the electrical and physical characteristics of the doped regions 28.

Gates 30, 31 may be formed on, and over, the doped regions 28. The gates 30, 31 may include a gate dielectric layer 32 and a gate conductor layer 34 that includes a portion that overlaps with the gate dielectric layer 32. In an embodiment, the gate dielectric layer 32 may be comprised of a dielectric material, such as an oxide of silicon like silicon dioxide, and the gate conductor layer 34 may be comprised of a conductor, such as doped polysilicon. A dielectric spacer 35 comprised of a dielectric material, such as silicon nitride, may be formed that surrounds each of the gates 30, 31.

A back-end-of-line stack 36 may be formed over the device structure 20. The back-end-of-line stack 36 may include dielectric layers 37 belonging to multiple metallization levels that are arranged in a layer stack. The dielectric layers 37 of the back-end-of-line stack 36 may be comprised of dielectric materials, such as silicon dioxide, silicon nitride, tetraethylorthosilicate silicon dioxide, and/or fluorinated-tetraethylorthosilicate silicon dioxide.

The back-end-of-line stack 36 may include airgaps 38 that are arranged in one or more of the dielectric layers 37 of the back-end-of-line stack 36. The airgaps 38 may be formed by defining cavities in at least one of the dielectric layers 37 and sealing the cavities with a subsequently deposited dielectric layer. The airgaps 38 that are unfilled by solid dielectric material and are instead filled by a gas, such as air. The airgaps 38 may be characterized by a permittivity or dielectric constant of near unity (i.e., vacuum permittivity), which is less than the permittivity of solid dielectric material. The airgaps 38 may be filled by atmospheric air at or near atmospheric pressure, may be filled by another gas at or near atmospheric pressure, or may contain atmospheric air or another gas at a sub-atmospheric pressure (e.g., a partial vacuum). In an embodiment, the gates 30, 31 of the device structure 20 may be arranged between the airgaps 38 and the semiconductor substrate 16. In alternative embodiments, additional airgaps (not shown) may be formed adjacent to the device structure 20 at other locations inside the back-end-of-line stack 36.

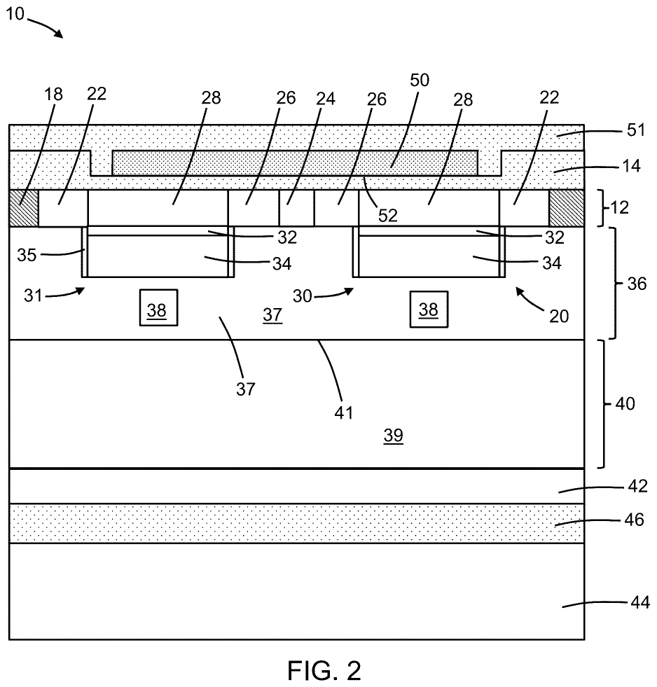

With reference to FIG. 2 in which like reference numerals refer to like features in FIG. 1 and at a subsequent fabrication stage, the back-end-of-line stack 36 may be bonded to a back-end-of-line stack 40 disposed on another substrate by a wafer bonding technique that provides a face-to-face bond along a bonding interface 41 by dielectric bonding or hybrid bonding, and the semiconductor substrate 16 may be removed by etching and/or griding to reveal the dielectric layer 14. The back-end-of-line stack 40 may include dielectric layers 39 belonging to multiple metallization levels that are arranged in a layer stack. The dielectric layers 39 of the back-end-of-line stack 40 may be comprised of dielectric materials, such as silicon dioxide, silicon nitride, tetraethylorthosilicate silicon dioxide, and/or fluorinated-tetraethylorthosilicate silicon dioxide. In an embodiment, the substrate on which the back-end-of-line stack 40 is formed may be a silicon-on-insulator substrate that includes a semiconductor layer 42, a semiconductor substrate 44, and a dielectric layer 46 between the semiconductor layer 42 and the semiconductor substrate 44. The substrate on which the back-end-of-line stack 40 is formed may include device structures, such as transistors, formed using semiconductor layer 42. The bonded construction provides a composite photonic chip.

A waveguide core 50 may be formed in a recess 52 that is patterned in the dielectric layer 14. The patterning of the recess 52 may locally thin the dielectric layer 14 at the location of the waveguide core 50. A passivation layer 51 comprised of a dielectric material, such as an oxide of silicon like silicon dioxide, may be formed directly on the dielectric layer 14 and waveguide core 50 because of the prior removal of the semiconductor substrate 16.

The device structure 20 is positioned in a vertical direction between the semiconductor substrate 44 and the waveguide core 50. The device structure 20 is positioned on one side of the bonding interface 41 and the waveguide core 50 is positioned on an opposite side of the bonding interface 41. The waveguide core 50 is separated from the nearest portion of the device structure 20 by the thickness of the dielectric layer 14 inside the recess 52, which provides low-index cladding. The thickness of the dielectric layer 14 inside the recess 52 can be selected to optimize heat transfer and optical power isolation as competing factors. The airgaps 38 may function to reduce the heat loss from the device structure 20 and thereby improve the efficiency of the heat transfer to the waveguide core 50.

In an embodiment, the waveguide core 50 may be comprised of a material having a refractive index that is greater than the refractive index of an oxide of silicon, such as silicon dioxide. In an embodiment, the waveguide core 50 may be comprised of a dielectric material, such as silicon nitride, silicon oxynitride, or aluminum nitride, having a high refractive index than silicon dioxide. In an embodiment, the waveguide core 50 may be comprised of silicon nitride. In an alternative embodiment, the waveguide core 50 may be comprised of a semiconductor material, such as silicon or germanium. In alternative embodiments, other materials, such as a polymer, diamond, thin-film lithium niobate, boron nitride, barium titanate, or a III-V compound semiconductor, may be used to form the waveguide core 50. In an embodiment, the waveguide core 50 may be formed by depositing a layer comprised of its constituent material and patterning the deposited layer with lithography and etching processes.

The dielectric material of the passivation layer 51 may fill space inside the recess 52 that is not occupied by the waveguide core 50. Electrical interconnections (not shown) may be formed that include contacts extending through the dielectric layer 14 and the passivation layer 51 to the device structure 20 and/or electrical interconnections (not shown) may be formed in the dielectric layers 37 of the back-end-of-line stack 36 that are coupled to the device structure 20.

In use, the waveguide core 50 guides propagating light past the device structure 20. Heat is generated by the operational power field-effect transistor embodied in the device structure 20. The generated heat is transferred from the device structure 20 through the thinned dielectric layer 14 to an adjacent section of the waveguide core 50. The temperature of the adjacent section of the waveguide core 50 is elevated by the transferred heat, which is effective to change the refractive index of the material of the heated section of the waveguide core 50 and thereby change the phase of the propagating light.

The device structure 20 represents a heater that can be deployed on a composite photonic chip in a thermo-optic phase shifter and used to modulate the phase of light in a section of the waveguide core 50 by locally varying the refractive index of its material. The power needed to achieve a given phase shift may be reduced in comparison with a conventional thermo-optic phase shifter. The thermo-optic phase shifter may occupy a smaller area and have a smaller footprint than a conventional thermo-optic phase shifter. The waveguide core 50 may be placed closer to the heater than in conventional constructions.

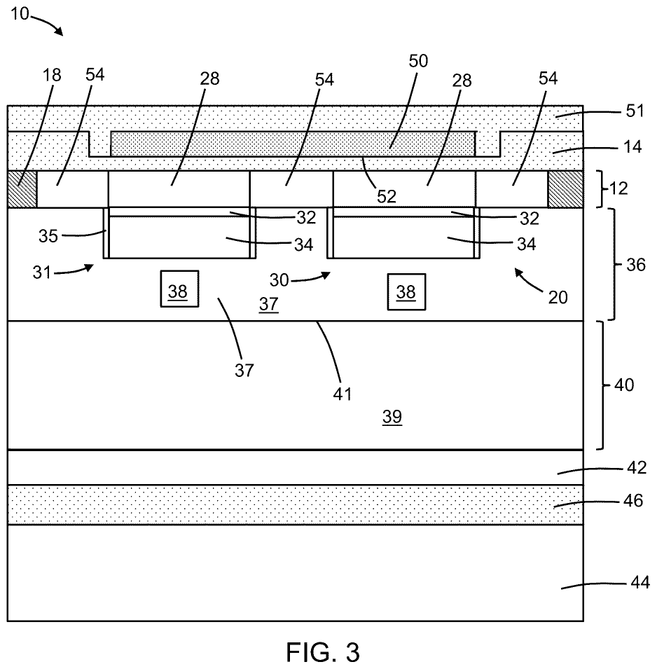

With reference to FIG. 3 and in accordance with alternative embodiments of the invention, the device structure 20 may be a field-effect transistor that includes the gates 30, 31 and source/drain regions 54 in the semiconductor layer 12. In an embodiment, the source/drain regions 54 may contain a concentration of an n-type dopant, such as phosphorus, to provide n-type conductivity. The source/drain regions 54 may be formed by implanting ions, such as ions including the n-type dopant, with an implantation mask having openings defining the intended locations for the source/drain regions 54 in the semiconductor substrate 16. The implantation conditions, such as ion species, dose, and kinetic energy, may be selected to tune the electrical and physical characteristics of the source/drain regions 54. The gates 30, 31 may represent gate fingers of a multiple-finger gate structure that are connected together at one end. The field-effect transistor may be a floating body transistor, a body-contacted transistor, a body-source tied configuration transistor, etc.

The temperature of the adjacent section of the waveguide core 50 is elevated by the heat originating from the operational field-effect transistor embodied in the device structure 20, which is effective to change the refractive index of the material of the heated section of the waveguide core 50 and thereby change the phase of the propagating light.

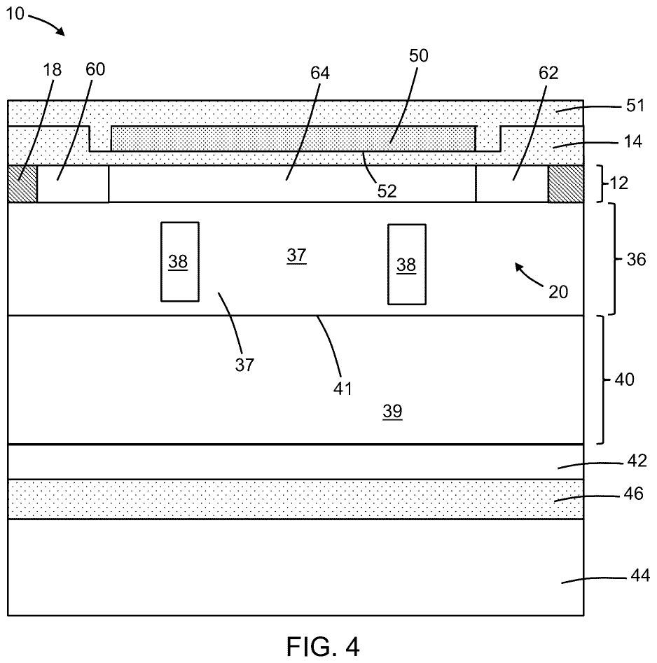

With reference to FIG. 4 and in accordance with alternative embodiments of the invention, the device structure 20 may be a bipolar junction transistor that includes an emitter 60, a collector 62, and an intrinsic base 64 representing terminals. The intrinsic base 64 defines a p-n junction with the emitter 60 and another p-n junction with the collector 62. In an NPN bipolar junction transistor, the emitter 60 and collector 62 are comprised of n-type semiconductor material, and the intrinsic base 64 is comprised of p-type semiconductor material. In a PNP bipolar junction transistor, the emitter 60 and collector 62 are comprised of p-type semiconductor material, and the intrinsic base 64 is comprised of n-type semiconductor material. In operation, the base-emitter p-n junction is forward biased, the base-collector p-n junction is reverse biased, and the collector-emitter current may be controlled with a base-emitter voltage.

In an embodiment, the device structure 20 may be a lateral bipolar junction transistor in which the intrinsic base 64 is positioned laterally between the emitter 60 and the collector 62. In alternative embodiments, the device structure 20 may be a vertical bipolar junction transistor or a vertical heterojunction bipolar transistor. In an embodiment, the device structure 20 may be a heterojunction bipolar transistor, which is a variant of a bipolar junction transistor in which the semiconductor materials have different energy bandgaps. For example, the emitter 60 and collector 62 of a heterojunction bipolar transistor may be constituted by silicon, and the intrinsic base 64 of a heterojunction bipolar transistor may be constituted by silicon-germanium, which is characterized by a narrower band gap than silicon.

The temperature of the adjacent section of the waveguide core 50 is elevated by the heat originating from the operational bipolar junction transistor embodied in the device structure 20, which is effective to change the refractive index of the material of the heated section of the waveguide core 50 and thereby change the phase of the propagating light. The waveguide core 50 may be placed in closer proximity to the device structure 20 than in conventional phase shifters. For example, the waveguide core 50 may be placed within 500 nanometers, or less, of the device structure 20.

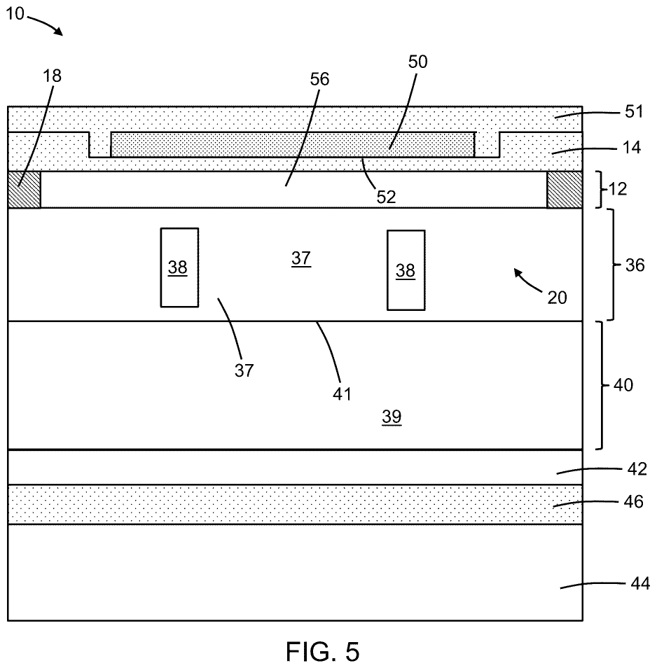

With reference to FIG. 5 and in accordance with alternative embodiments of the invention, the device structure 20 may include a resistive heating element 56 that comprises either silicon or a metal. The resistive heating element 56 may be contacted at opposite ends by an anode terminal and a cathode terminal. The resistive heating element 56 is configured to generate heat by Joule heating caused by an electrical current flowing between the anode terminal and the cathode terminal.

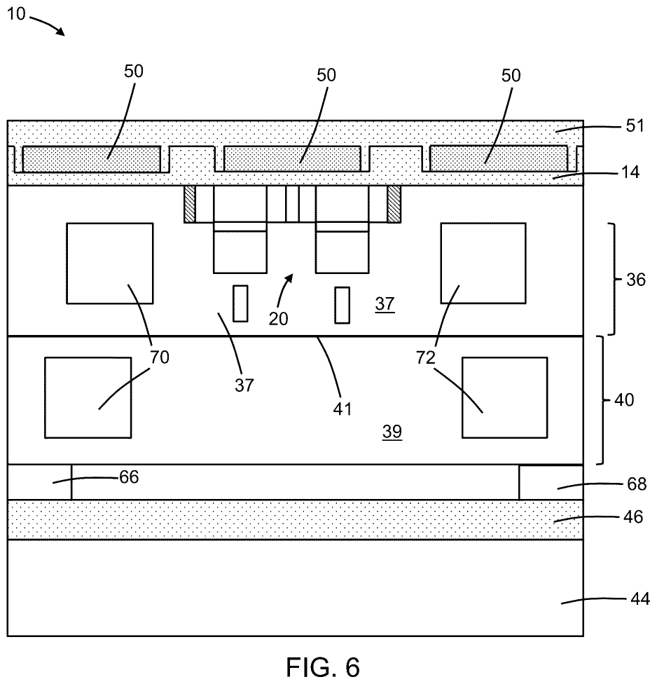

With reference to FIG. 6 and in accordance with alternative embodiments of the invention, the structure 10 may include a waveguide core 66 and a waveguide core 68 that are positioned on the dielectric layer 46 of the substrate that is wafer bonded to the substrate that includes the device structure 20 and the waveguide core 50. In an embodiment, the waveguide cores 66, 68 may be formed by patterning the semiconductor layer 42 with lithography and etching processes.

An optical coupler 70 may include a portion within the back-end-of-line stack 36 and a portion within the back-end-of-line stack 40, and these portions of the optical coupler 70 cooperate to transfer light across the bonding interface 41 between the waveguide core 66 and a section of the waveguide core 50. An optical coupler 72 may include a portion within the back-end-of-line stack 36 and a portion within the back-end-of-line stack 40, and these portions of the optical coupler 72 cooperate to transfer light across the bonding interface 41 between the waveguide core 68 and another section of the waveguide core 50. The added sections of the waveguide core 50 may be formed recesses, similar to the recess 52, that are patterned in the dielectric layer 14 to provide locally-thinned layers of dielectric material. In an embodiment, the optical couplers 70, 72 may include heterogenous layer stacks containing layers of nitrogen-doped silicon carbide or nitrogen-doped hydrogenated silicon carbide.

The optical couplers 70, 72 provide an escalator for interlevel light transfer between levels at different elevations on the composite photonic chip and across the bonding interface 41.

The sections of the waveguide core 50 involved in the light transfers may be coupled in a routing path to the section of the waveguide core 50 that is heated by the device structure 20 to provide a phase shift of the propagating light. For example, the waveguide core 66 may provide light as input to the structure 10 that is transferred by the optical coupler 70 across the bonding interface 41 to a section of the waveguide core 50, the device structure 20 may be used to phase shift the light, and the optical coupler 72 may transfer the phase-shifted light across the bonding interface 41 from a section of the waveguide core 50 to the waveguide core 68 for output from the structure 10.

The temperature of the section of the waveguide core 50 proximate to the device structure 20 is elevated by the heat originating from the operational bipolar junction transistor embodied in the device structure 20, which is effective to change the refractive index of the material of the heated section of the waveguide core 50 and thereby change the phase of the propagating light.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure comprising:
a dielectric layer;
a heater on the dielectric layer;
a first back-end-of-line stack on the dielectric layer and the heater;
a substrate;
a second back-end-of-line stack on the substrate, the second back-end-of-line stack adjoining the first back-end-of-line stack along a bonding interface; and
a first waveguide core on the dielectric layer, the first waveguide core including a first section that overlaps with the heater.

2. The structure of claim 1 wherein the dielectric layer includes a portion that is positioned between the heater and the first waveguide core.

3. The structure of claim 2 wherein the dielectric layer includes a recess, and the first waveguide core is positioned inside the recess in the dielectric layer.

4. The structure of claim 1 wherein the dielectric layer is positioned between the heater and the first waveguide core.

5. The structure of claim 1 wherein the dielectric layer includes a recess, and the first waveguide core is positioned inside the recess in the dielectric layer.

6. The structure of claim 1 further comprising:
a semiconductor layer positioned between the dielectric layer and the first back-end-of-line stack.

7. The structure of claim 6 wherein the heater is a power field-effect transistor that includes a source region and a drain region in the semiconductor layer.

8. The structure of claim 6 wherein the heater is a bipolar junction transistor that includes a terminal in the semiconductor layer.

9. The structure of claim 6 wherein the heater is a field-effect transistor that includes a gate on the semiconductor layer.

10. The structure of claim 1 wherein the dielectric layer is a buried oxide layer of a silicon-on-insulator substrate.

11. The structure of claim 1 wherein the first back-end-of-line stack includes one or more dielectric layers and an airgap in the one or more dielectric layers, and the airgap is positioned between the heater and the second back-end-of-line stack.

12. The structure of claim 11 further comprising:
a second waveguide core on the substrate;
a first optical coupler including a first portion in the first back-end-of-line stack and a second portion in the second back-end-of-line stack,
wherein the first optical coupler is configured to transfer light between the first waveguide core and the second waveguide core.

13. The structure of claim 12 further comprising:
a third waveguide core on the substrate;
a second optical coupler including a first portion in the first back-end-of-line stack and a second portion in the second back-end-of-line stack,
wherein the second optical coupler is configured to transfer light between the first waveguide core and the third waveguide core.

14. The structure of claim 1 further comprising:
a passivation layer directly on the dielectric layer and the first waveguide core.

15. The structure of claim 1 wherein the heater is a resistive heating element.

16. The structure of claim 1 wherein the dielectric layer is a buried oxide layer of a silicon-on-insulator substrate, and further comprising:
a passivation layer directly on the buried oxide layer and the first waveguide core.

17. The structure of claim 16 wherein the silicon-on-insulator substrate lacks a semiconductor substrate adjoining the buried oxide layer.

18. The structure of claim 1 wherein the first waveguide core comprises a dielectric material having a higher refractive index than silicon dioxide.

19. The structure of claim 1 wherein the first waveguide core comprises silicon nitride.

20. A method comprising:
forming a heater on a dielectric layer;
forming a first back-end-of-line stack on the dielectric layer and the heater;
bonding a second back-end-of-line stack to the first back-end-of-line stack along a bonding interface, wherein the second back-end-of-line stack is positioned on a substrate; and
forming a waveguide core on the dielectric layer, wherein the waveguide core includes a section that overlaps with the heater.
